(19) United States
(12) Patent Application Publication
(10) Pub. No.: US 2008/0054222 A1
(43) Pub. Date: Mar. 6, 2008

(54) SCINTILLATOR AND SCINTILLATOR PLATE FITTED WITH THE SAME

(76) Inventors: Mika SAKAI, Tokyo (JP); Takehiko Shoji, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/846,300

(22) Filed: Aug. 28, 2007

(30) Foreign Application Priority Data
Aug. 31, 2006 (JP) JP2006-235339

(51) Int. Cl. C09K 11/61

(52) U.S. Cl. 252/301.4 H

(57) ABSTRACT

Provided are a scintillator and a scintillator plate fitted with the scintillator exhibiting high emission luminance even though a heat treatment temperature of CsI columnar crystals is high, and also capable of exhibiting high emission luminance since these crystals can be formed on each of various kinds of evaporation substrates. Also disclosed is a scintillator comprising columnar crystals formed via vapor deposition of cesium iodide and an additive comprising a thallium compound, wherein the thallium compound has a melting point of 400-700° C., and has a molecular weight of 206-300.

This application claims priority from Japanese Patent Application No. 2006-235339 filed on Aug. 31, 2006, which is incorporated hereinto by reference.

### TECHNICAL FIELD

The present invention relates to a scintillator and a scintillator plate fitted with the same.

### BACKGROUND

Generally, radiographic images such as X-ray images have been commonly utilized for diagnoses of condition of a patient at medical scenes. In particular, radiographic images by an intensifying screen-film system, as a result of achievement of a high sensitivity and a high image quality during the long improvement history, are still utilized at medial scenes all over the world as an image pick-up system provided with the both of high reliability and superior cost performance.

However, the image information is so-called analogue image information, and it is impossible to perform free image processing and image transmission in a moment as with digital image information which has been ever developing in recent years.

Therefore, in recent years, a radiographic image detector system such as computed radiography (CR) and flat-panel type radiation detector (FPD) has come to be in practical use. Since these can directly obtain a digital radiographic image and directly display the image on an image display device such as a cathode ray tube and a liquid crystal panel, there is not necessarily required image formation on photographic film. As a result, these digital X-ray image detector systems have decreased necessity of image formation by silver salt photography and significantly improved convenience of diagnostic works at hospitals and clinics.

Computed radiography (CR) has come to be in practical use in medical scenes at present as one of digital technologies of X-ray images. “Stimulable phosphor plate” used for CR causes stimulated emission in intensity corresponding to a dose of accumulated radiation upon exposure to stimulating light via accumulation of radiation passing through an object, and has a structure in which the stimulable phosphor is formed in laminae on the prearranged substrate. One example of a method of manufacturing such the stimulable phosphor panel is disclosed in Patent Document 1.

In the method described in Patent Document 1, a stimulable phosphor is formed on the substrate via a commonly known vapor deposition method, and the substrate is subjected to heat treatment.

However, the stimulable phosphor plate exhibits neither sufficient sharpness nor spatial resolution, and has not achieved an image quality of a screen-film system. In addition, flat plate X-ray detector system (FPD) employing thin film transistor (TFT), described in such as “Amorphous Semiconductor Usher in Digital X-ray Imaging” by John Rawlands, Physics Today, 1997 November, p. 24, and “Development of a High Resolution, Active Matrix, Flat-Panel Imager with Enhanced Fill Factor” by L. E. Anthonuk, SPIE, 1997, vol. 32, p. 2, as a further new digital X-ray image technology has been developed.

“Scintillator plate” used for the FPD causes instantaneous luminescence corresponding to radiation passing through an object, and has a structure in which the scintillator (phosphor) is formed in laminae on the prearranged substrate.

In order to enhance sharpness of a stimulable phosphor plate or a scintillator plate, disclosed is a method of manufacturing a radiation image conversion panel obtained by forming a phosphor layer via vapor deposition. The vapor deposition method comprises an evaporation method and a sputtering method. The evaporation method, for example, is a method in which an evaporation source composed of phosphor raw material is heated with a resistance heater or upon exposure to an electron beam to evaporate the evaporation source, and the evaporated material is deposited on the substrate surface to form a phosphor layer having phosphor columnar crystals.

Since a phosphor layer formed via vapor deposition contains no binder but phosphor only, and the phosphor is composed from columnar crystals, scattering of stimulating light used in a CR system and scattering of emission light in an FPD system are inhibited, whereby a high sharpness image can be obtained. However, sufficient luminance has not been obtained in both systems.

As for CR, stimulated luminescence is taken out in intensity corresponding to the dose for radiation accumulated upon exposure to stimulating light, but an SN ratio drops because of a low amount of accumulated energy, whereby insufficient image quality has been obtained.

Flat-panel type X-ray detector (FPD) is more miniaturized than CR, and has a feature of an excellent image at a high dose. However, on the other hand, a large electric noise possessed by a TFT or the circuit itself causes reduction of a SN ratio in image pick-up at a low dose, whereby insufficient image quality has still been obtained.

In order to improve a SN ratio in image pick-up with a radiation image detecting plate utilized for CR and FPD, a radiation image detecting plate exhibiting a high emission efficiency is to be desired. The high emission efficiency of the radiation image detecting plate depends generally on thickness of a phosphor layer and X-ray absorption coefficient of phosphor, but the thicker the phosphor layer is, the more emission light is scattered in a phosphor layer, whereby sharpness drops. Thus, when sharpness associated with image quality is determined, thickness is also determined.

Above all, cesium bromide (CsBr) utilized for a stimulable phosphor plate and cesium iodide (CsI) utilized for a scintillator plate exhibit a relatively high conversion ratio of X-rays to visible light, and are capable of easily forming phosphor columnar crystals via evaporation. Thus, scattering of emission light in the columnar crystals is reduced because of a light guiding effect, whereby the thickness of the phosphor layer is possible to be increased.

Various additives are employed, since the emission efficiency is low in the case of only using CsBr or CsI. It is known that the emission efficiency is increased by containing an additive content of at least 0.001 mol %, based on that of CsI or CsBr. As shown in Japanese Patent Examined Publication No. 54-35060, a mixture of CsI and sodium iodide (NaI) in arbitrary molar ratio is deposited on a substrate as sodium activated cesium iodide (CsI:Na) via evaporation, and subsequently annealed in the post-process to improve the visible light conversion efficiency, whereby the resulting is utilized as X-ray phosphor.

In the case of CsI crystals obtained via evaporation, the sufficient luminescence amount can not be obtained without conducting a baking process generally at 300° C. or more, but in the case of employing an α-Si:H film as a photoelectric conversion film, it is disclosed in Japanese Patent O.P.I. Publication No. 5-180945 that the α-Si:H film is deteriorated in the process of baking CsI crystals obtained via evaporation. Further in the process of baking CsI crystals obtained via evaporation, an X-ray image conversion scintillator does not play an enough role in X-ray image conversion, since a film tends to be peeled off a resin substrate.

The limitation of kinds of substrates depending on the heat treatment temperature produces a problem.

(Patent Document) Japanese Patent O.P.I. Publication No. 2003-279696 (paragraph Nos. 0034 and 0035).

### SUMMARY

The present invention is made on the basis of the above-described situation. It is an object of the present invention to provide a scintillator and a scintillator plate fitted with the scintillator exhibiting high emission luminance even though a heat treatment temperature of CsI columnar crystals is high, and also capable of exhibiting high emission luminance since these crystals can be formed on each of various kinds of evaporation substrates. Also disclosed is a scintillator comprising columnar crystals formed via vapor deposition of cesium iodide and an additive comprising a thallium compound, wherein the thallium compound has a melting point of 400-700° C., and has a molecular weight of 206-300.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is a cross-sectional view of a scintillator plate; and

FIG. 2 is a schematic diagram of an evaporator.

### DESCRIPTION OF THE PREFERRED EMBODIMENTS

The above object of the present invention is accomplished by the following structures.

(Structure 1) A scintillator comprising columnar crystals formed via vapor deposition of cesium iodide and an additive comprising a thallium compound, wherein the thallium compound has a melting point of 400-700° C., and has a molecular weight of 206-300.

(Structure 2) The scintillator of Structure 1, wherein the thallium compound is thallium bromide, thallium chloride or thallium fluoride.

(Structure 3) The scintillator of Structure 1 or 2, heat-treated at 140-250° C. during or after evaporating the cesium iodide and the additive.

(Structure 4) The scintillator of any one of Structures 1-3, formed on a substrate comprising a resin film.

(Structure 5) The scintillator of any one of Structures 1-4, formed on a light-receiving element plane comprising a plurality of pixels.

(Structure 6) The scintillator of Structure 4, wherein the resin film contains polyimide or polyethylene naphthalate.

(Structure 7) A scintillator plate comprising the scintillator of any one of Structures 1-6.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

It is a feature in the present invention to provide a scintillator comprising columnar crystals formed via vapor deposition of cesium iodide and an additive comprising a thallium compound, wherein the thallium compound has a melting point of 400-700° C., and has a molecular weight of 206-300.

“Scintillator” of the present invention means phosphor which absorbs energy of incident radiation such as X-ray, and emits electromagnetic waves having a wavelength of 300-800 nm, namely light in the range of from ultraviolet to infrared covering visible light.

Next, constituent elements of the present invention will be described in detail.

### (Raw Material)

A Scintillator is formed via vapor deposition of cesium iodide and an additive comprising a thallium compound that are employed as raw material.

It is a feature that the additive contains at least a thallium compound. Various kinds of thallium compounds (compounds having the oxidation number of +I or +III) are employed as the thallium compound. In the present invention, examples of preferable thallium compounds include thallium bromide, thallium chloride and thallium fluoride.

The thallium compound of the present invention preferably has a melting point of 400-700° C. In the case of a temperature exceeding 700° C., emission efficiency drops since additives are unevenly present in columnar crystals. Incidentally, the melting point of the present invention means a melting point at room temperature and normal pressure.

In this case, the thallium compound preferably has a molecular weight of 206-300.

As for a scintillator of the present invention, the additive content depending on the purpose as well as performance is desired to be adjusted to an optimum amount, but it is preferably 0.001-50 mol %, and more preferably 0.1-10.0 mol %, based on the content of cesium iodide.

In the case of an additive content of less than 0.001 mol %, based on the content of cesium iodide, emission luminance is at the same level as that of cesium iodide singly, and the intended emission luminance can not be obtained. In the case of an additive content exceeding 50 mol %, no property and function of cesium iodide can be obtained.

### (Substrate)

Various kinds of substrates are usable, when scintillator plates of the present invention are prepared. This is a feature of the present invention.

That is, various kinds of glass, polymeric materials and metals which are capable of transmitting radiation such as X-rays are usable for the substrates. Usable examples thereof include a plate glass substrate made of quartz, borosilicate glass, chemically tempered glass or such; a ceramic substrate made of sapphire, silicon nitride, silicon carbide or such; a semiconducting substrate made of silicon, germanium, gallium arsenide, gallium nitride or such; a plastic film made of cellulose acetate, polyester, polyethylene terephthalate, polyamide, polyimide, triacetate, polycarbonate, carbon fiber reinforced resin or such; a metal sheet made of aluminum, iron, copper or such; and a metal sheet having a coated layer made of a metal thereof.

Specifically, the scintillator of the present invention is suitable in the case of forming a scintillator with columnar crystals prepared via vapor deposition of cesium iodide as raw material on a resin film containing polyimide or polyethylene terephthalate, or the plane (α-Si:H film, for example) of a light-receiving element having a plurality of pixels that are two-dimensionally placed.

Incidentally, the substrate preferably has a thickness of 0.1-2 mm in view of improved durability and reduction in weight.

### (Method of Preparing Scintillator and Scintillator Plate)

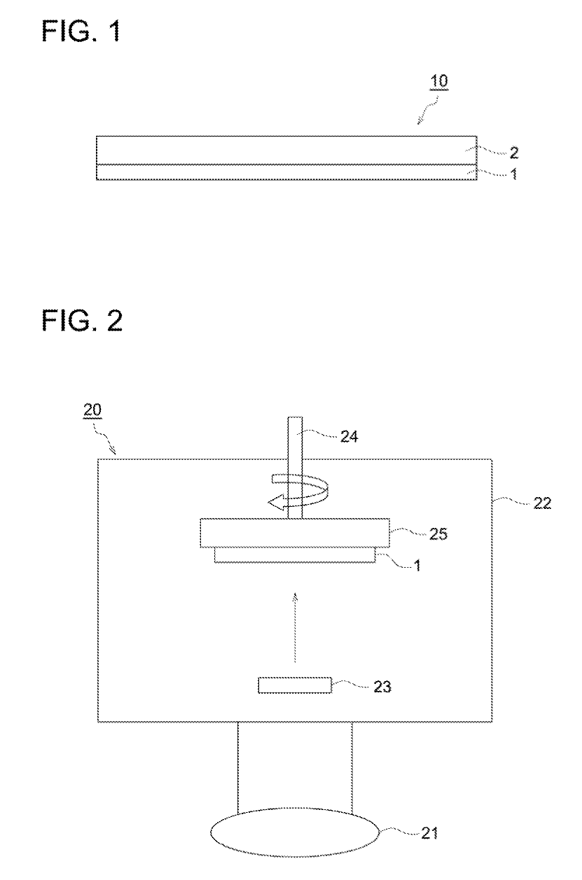

The scintillator and scintillator plate of the present invention will be described referring to FIG. 1.

As shown in FIG. 1, scintillator plate 10 in the present invention comprises substrate 1 and provided thereon scintillator (phosphor layer) 2. When scintillator (phosphor layer) 2 is exposed to radiation, the scintillator absorbs energy of incident radiation, and emits electromagnetic waves having a wavelength of 300-800 nm, namely light in the range of from ultraviolet to infrared covering visible light.

A method of forming scintillator (phosphor layer) 2 on substrate 1 will be described below.

Scintillator (phosphor layer) 2 is formed via vacuum evaporation. Substrate 1 is placed in a commonly known vacuum evaporator; raw material used for scintillator (phosphor layer) 2 containing the foregoing additives is filled in as an evaporation source; inert gas such as nitrogen is subsequently introduced from the inlet to obtain a vacuum degree of 1.333−1.333×10⁻³ Pa while evacuating the inside of the evaporator; and at least one phosphor raw material is evaporated by heating employing a resistance heating method or an electron beam method to form a phosphor layer having a desired thickness. Thus, scintillator (phosphor layer) 2 is formed on substrate 1. This vacuum evaporation is possible to be separately carried out in a plurality of times to form scintillator (phosphor layer) 2. For example, a plurality of evaporation sources having the same composition are prepared, and evaporation is repeatedly conducted until reaching a desired thickness of scintillator (phosphor layer) 2 in such a way that an evaporation source is evaporated one after another.

Incidentally, additives with respect to CsI are to be evenly contained in a film of scintillator (phosphor layer) 2 formed on substrate 1. The luminescence amount distribution in a phosphor layer formed on substrate 1 is possible to be more evenly produced by employing additives having a melting point of the foregoing thallium compound of 400-700° C.

Substrate 1 may be cooled or heated during evaporation, if desired. Scintillator (phosphor layer) 2 together with substrate 1 may also be heat-treated after completing evaporation.

In the present invention, a heat treatment of 140-250° C. is preferably carried out during or after evaporation of raw material (refer to Tables 2 and 3).

Next, evaporator 20 as an example of an evaporator for a vacuum evaporation will be described, referring to FIG. 2.

Evaporator 20 is equipped with vacuum vessel 22 in which a vacuum degree is adjusted via operation of vacuum pump 21. Resistance heating crucible 23 is placed inside vacuum vessel 22 as an evaporation source, and substrate 1 rotatable with rotational mechanism 24 is placed via substrate holder 25 on the upper side of resistance heating crucible 23. A slit to adjust phosphor vapor flow coming from resistance heating crucible 23 is also placed between resistance heating crucible 23 and substrate 1, if desired. In addition, substrate 1 is designed to be placed on substrate holder 25 when operating evaporator 20.

Next, the function of scintillator plate 10 will be described.

When radiation enters from the side of scintillator (phosphor layer) 2 toward the side of substrate 1 with respect to scintillator 10, energy of radiation incoming into scintillator (phosphor layer) 2 is absorbed by phosphor particles in scintillator (phosphor layer) 2, and electromagnetic waves corresponding to the intensity is emitted from scintillator (phosphor layer) 2.

In this case, the luminescence amount distribution in a phosphor layer formed on substrate 1 is evenly produced, and columnar crystals constituting scintillator (phosphor layer) 2 each are formed with regularity. As a result, scintillator (phosphor layer) 2 improves emission efficiency in the case of instantaneous luminescence, whereby sensitivity to radiation of scintillator plate 10 is largely improved.

As described above, in scintillator plate 10 of the present invention, the emission efficiency of scintillator (phosphor layer) 2 can be significantly improved upon exposure to enhance emission luminance. Thus, an SN ratio in image pick-up at a low dose for the resulting radiation image can also be improved. Incidentally, a scintillator plate of the present invention is applicable to a radiation image conversion panel.

### EXAMPLE

Next, the present invention will be explained employing examples, but the present invention is not limited thereto.

### Example 1

### Preparation of Substrate for Evaporation

A polyimide resin film of having a thickness of 125 μm was cut to a square, 10 cm on a side to obtain a substrate.

### (Preparation of Scintillator)

Cesium iodide and the additive (0.3 mol % based on CsI) shown in Table 1 were mixed, and filled in a resistance heating crucible as an evaporation material. A substrate is also placed on a rotatable substrate holder, and a distance between the substrate and the evaporation source was adjusted to 400 mm.

Next, the inside of the evaporator was first evacuated and then, Ar gas was introduced thereto to adjust the vacuum degree to 0.1 Pa. Thereafter, temperature of substrate 1 was maintained at each of 130, 200 and 300° C. as an evaporation temperature as shown in Table 2, while rotating substrate 1 at 10 rpm. Subsequently, the resistance heating crucible was heated to evaporate phosphor for the scintillator, and evaporation was completed when the scintillator (phosphor layer) reached a thickness of 500 μm to obtain a scintillator.

### (Heat Treatment)

Standing at an evaporation temperature of 130° C., and heat treatment conducted at 180, 250 and 300° C. for 2 hours as shown in the following Table 3. The resulting luminance data after heat treatment are also shown in Table 3.

### (Measurement of Luminance)

Each sample was exposed to X-ray generated at a bulb voltage 80 kVp from the back side of each sample [the side having no scintillator (phosphor layer)] and light instantaneously emitted from the sample was taken out through an optical fiber. The luminescence amount was measured by a photodiode (S2281) manufactured by Hamamatsu Photonics Co., Ltd. Thus obtained measured value was defined as “emission luminance (sensitivity)”. The results are shown in the following Table 2 and Table 3. As shown in Table 2 and Table 3, the emission luminance of each sample was a relative value when the emission luminance of the comparative example after evaporation at 130° C. with no heat treatment was set to 1.0.

### Example 2

### Preparation of Substrate for Evaporation

A light-receiving element plane (α-Si:H film) having a square, 10 cm on a side was prepared as a substrate.

### (Preparation of Scintillator)

Cesium iodide and the additive (0.3 mol % based on CsI) shown in Table 1 were mixed to prepare an evaporation material, and temperature of substrate 1 was maintained at each of 100, 200 and 300° C. as an evaporation temperature.

### (Heat Treatment)

Standing at an evaporation temperature of 100° C., and heat treatment conducted at 180, 250 and 300° C. for 2 hours as shown in the following Table 5.

### (Measurement of Luminance)

The luminance was measured in the same way as in Example 1.

TABLE 1

| | | Melting | |
|---|---|---|---|
| | | point | Molecular |
| | Utilized additive | (° C.) | weight |
| Example | Thallium bromide | 460 | 284.29 |
| | (TlBr) | | |
| | Thallium chloride | 430 | 239.84 |
| | (TlCl) | | |
| Comparative | Thallium iodide | 441 | 331.29 |
| example | (TlI) | | |

TABLE 2

| | | Luminance before heat treatment | | |
|---|---|---|---|---|
| | | Evaporation temperature | | |
| PI substrate | Additive | 130° C. | 200° C. | 300° C. |
| Example | Thallium | 2.6 | 2.9 | Film peeled |
| | bromide | | | |
| | (TlBr) | | | |
| Example | Thallium | 2.3 | 2.7 | |
| | chloride | 2.3 | 2.7 | |
| | (TlCl) | | | |
| Comparative | Thallium | 1 | 1.2 | |
| example | iodide (TlI) | | | |

PI: polyimide

TABLE 3

| | | Luminance after heat treatment | | | |
|---|---|---|---|---|---|
| | | Standing at | | | |
| | | evaporation | | | |
| | | temperature | After heat treatment | | |
| PI substrate | Additive | of 130° C. | 180° C. | 250° C. | 300° C. |
| Example | Thallium | 2.6 | 2.75 | 3.05 | Film |
| | bromide | | | | peeled |
| | (TlBr) | | | | |
| Example | Thallium | 2.3 | 2.5 | 2.8 | |
| | chloride | | | | |
| | (TlCl) | | | | |
| Comparative | Thallium | 1 | 1.2 | 1.2 | |
| example | iodide | | | | |
| | (TlI) | | | | |

TABLE 4

| Photoelectric | | Luminance before heat treatment | | |
|---|---|---|---|---|
| conversion | | Evaporation temperature | | |
| α-Si:H film | Additive | 100° C. | 200° C. | 300° C. |
| Example | Thallium | 0.9 | 3 | Photoelectric |
| | bromide | | | conversion |
| | (TlBr) | | | α-Si:H film |
| Example | Thallium | 0.75 | 2.7 | deteriorated |
| | chloride | | | |
| | (TlCl) | | | |
| Comparative | Thallium | 1 | 1.2 | |
| example | iodide | | | |
| | (TlI) | | | |

TABLE 5

| | | Luminance after heat treatment | | | |
|---|---|---|---|---|---|
| | | Standing at | | | |
| Photoelectric | | evaporation | | | |
| conversion | | temperature | After heat treatment | | |
| α-Si:H film | Additive | of 100° C. | 180° C. | 250° C. | 300° C. |
| Example | Thallium | 0.9 | 2.8 | 3.1 | Photoelectric |
| | bromide | | | | conversion |
| | (TlBr) | | | | α-Si:H film |
| Example | Thallium | 0.75 | 2.4 | 2.8 | deteriorated |
| | chloride | | | | |
| | (TlCl) | | | | |
| Comparative | Thallium | 1 | 1.2 | 1.2 | |
| example | iodide | | | | |
| | (TlI) | | | | |

As is clear from the above-shown Tables, it is to be understood that the present invention can exhibit sufficient luminance by changing the additive, even though CsI columnar crystals are subjected to heat treatment at not higher than 250° C.

CsI columnar crystals can be formed on each of various kinds of evaporation substrates via evaporation. Thus, this can further exhibit sufficient emission luminance.

### EFFECT OF THE INVENTION

Through the above structures of the present invention, provided can be a scintillator and a scintillator plate fitted with the scintillator exhibiting high emission luminance even though a heat treatment temperature of CsI columnar crystals is high, and also capable of exhibiting high emission luminance since these crystals can be formed on each of various kinds of evaporation substrates.

What is claimed is:

1. A scintillator comprising columnar crystals formed via vapor deposition of cesium iodide and an additive comprising a thallium compound,
wherein the thallium compound has a melting point of 400-700° C., and has a molecular weight of 206-300.

2. The scintillator of claim 1,
wherein the thallium compound is thallium bromide, thallium chloride or thallium fluoride.

3. The scintillator of claim 1, heat-treated at 140-250° C. during or after evaporating the cesium iodide and the additive.

4. The scintillator of claim 1, formed on a substrate comprising a resin film.

5. The scintillator of claim 1, formed on a light-receiving element plane comprising a plurality of pixels.

6. The scintillator of claim 4,
wherein the resin film contains polyimide or polyethylene naphthalate.

7. A scintillator plate comprising the scintillator of claim 1.
